(19) United States
(12) Patent Application Publication
(10) Pub. No.: US 2025/0240771 A1
(43) Pub. Date: Jul. 24, 2025

(54) PAGING WITH CELL DISCONTINUOUS TRANSMISSION

(71) Applicant: NOKIA TECHNOLOGIES OY, ESPOO (FI)

(72) Inventors: Mads LAURIDSEN, Gistrup (DK); John HARRIS, Whitefish Bay, WI (US); Navin HATHIRAMANI, Coppell, TX (US); Cássio Barboza RIBEIRO, Espoo (FI)

(21) Appl. No.: 18/416,256

(22) Filed: Jan. 18, 2024

(51) Int. Cl. H04W 68/02; H04W 68/00; H04W 76/28

(52) U.S. Cl. CPC H04W 68/025; H04W 68/005; H04W 76/28

(57) ABSTRACT

Systems, methods, apparatuses, and computer program products for paging with cell DTX. One method may include obtaining, by a UE, information related to one or more paging early indications, and monitoring, by the UE, independent of a discontinuous operation state, at least one of the one or more paging early indications. The at least one monitored paging early indication indicates at least one of at least one cell discontinuous transmission state, at least one cell discontinuous reception state, a start of at least one cell discontinuous transmission state, a start of at least one cell discontinuous reception state, at least one paging occasion to monitor that corresponds to the at least one monitored paging early indication and independent of at least one cell discontinuous transmission state or at least one cell discontinuous reception state, or at least one paging occasion to monitor that corresponds to the at least one monitored paging early indication where the paging occasion is shifted to a next cell discontinuous transmission active period. The method further comprises monitoring, by the UE, paging according to the received information related to the one or more paging early indications.

### TECHNICAL FIELD

Some example embodiments may generally relate to mobile or wireless telecommunication systems, such as 3^{rd} Generation Partnership Project (3GPP) Long Term Evolution (LTE), 5^{th} generation (5G) radio access technology (RAT), new radio (NR) access technology, 6^{th} generation (6G), and/or other communications systems. For example, certain example embodiments may relate to systems and/or methods for paging with cell discontinuous transmission (DTX).

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include receiving, by a user equipment, paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging. The method may further include monitoring, by the user equipment, paging according to the received paging information.

In accordance with certain example embodiments, an apparatus may include means for receiving paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging. The apparatus may further include means for monitoring paging according to the received paging information.

In accordance with various example embodiments, a non-transitory computer readable medium may include program instructions that, when executed by an apparatus, cause the apparatus to perform at least a method. The method may include receiving paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging. The method may further include monitoring paging according to the received paging information.

In accordance with some example embodiments, a computer program product may perform a method. The method may include receiving paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging. The method may further include monitoring paging according to the received paging information.

In accordance with certain example embodiments, an apparatus may include at least one processor and at least one memory storing instructions that, when executed by the at least one processor, cause the apparatus at least to receive paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging. The at least one memory and instructions, when executed by the at least one processor, may further cause the apparatus at least to monitor paging according to the received paging information.

In accordance with various example embodiments, an apparatus may include receiving circuitry configured to perform receiving paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging. The apparatus may further include monitoring circuitry configured to perform monitoring paging according to the received paging information.

In accordance with some example embodiments, a method may include transmitting, by a network entity, paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging. The method may further include receiving, by the network entity, a paging response according to the transmitted paging information.

In accordance with certain example embodiments, an apparatus may include means for transmitting paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging. The apparatus may further include means for receiving a paging response according to the transmitted paging information.

In accordance with various example embodiments, a non-transitory computer readable medium may include program instructions that, when executed by an apparatus, cause the apparatus to perform at least a method. The method may include transmitting paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging. The method may further include receiving a paging response according to the transmitted paging information.

In accordance with some example embodiments, a computer program product may perform a method. The method may include transmitting paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging. The method may further include receiving a paging response according to the transmitted paging information.

In accordance with certain example embodiments, an apparatus may include at least one processor and at least one memory storing instructions that, when executed by the at least one processor, cause the apparatus at least to transmit paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging. The at least one memory and instructions, when executed by the at least one processor, may further cause the apparatus at least to receive a paging response according to the transmitted paging information.

In accordance with various example embodiments, an apparatus may include transmitting circuitry configured to perform transmitting paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging. The apparatus may further include receiving circuitry configured to perform receiving a paging response according to the transmitted paging information.

In accordance with some example embodiments, a method may include obtaining, by a user equipment, information related to one or more paging early indications. The method may further include monitoring, by the user equipment, independent of a discontinuous operation state, at least one of the one or more paging early indications. The at least one monitored paging early indication may indicate at least one of at least one cell discontinuous transmission state, at least one cell discontinuous reception state, a start of at least one cell discontinuous transmission state, a start of at least one cell discontinuous reception state, at least one paging occasion to monitor that corresponds to the at least one monitored paging early indication and independent of at least one cell discontinuous transmission state or at least one cell discontinuous reception state, or at least one paging occasion to monitor that corresponds to the at least one monitored paging early indication where the paging occasion is shifted to a next cell discontinuous transmission active period. The method may further include monitoring, by the user equipment, paging according to the received information related to the one or more paging early indications.

In accordance with certain example embodiments, an apparatus may include means for obtaining information related to one or more paging early indications. The apparatus may further include means for monitoring, independent of a discontinuous operation state, at least one of the one or more paging early indications. The at least one monitored paging early indication may indicate at least one of at least one cell discontinuous transmission state, at least one cell discontinuous reception state, a start of at least one cell discontinuous transmission state, a start of at least one cell discontinuous reception state, at least one paging occasion to monitor that corresponds to the at least one monitored paging early indication and independent of at least one cell discontinuous transmission state or at least one cell discontinuous reception state, or at least one paging occasion to monitor that corresponds to the at least one monitored paging early indication where the paging occasion is shifted to a next cell discontinuous transmission active period. The apparatus may further include means for monitoring paging according to the received information related to the one or more paging early indications.

In accordance with various example embodiments, a non-transitory computer readable medium may include program instructions that, when executed by an apparatus, cause the apparatus to perform at least a method. The method may include obtaining information related to one or more paging early indications. The method may further include monitoring, independent of a discontinuous operation state, at least one of the one or more paging early indications. The at least one monitored paging early indication may indicate at least one of at least one cell discontinuous transmission state, at least one cell discontinuous reception state, a start of at least one cell discontinuous transmission state, a start of at least one cell discontinuous reception state, at least one paging occasion to monitor that corresponds to the at least one monitored paging early indication and independent of at least one cell discontinuous transmission state or at least one cell discontinuous reception state, or at least one paging occasion to monitor that corresponds to the at least one monitored paging early indication where the paging occasion is shifted to a next cell discontinuous transmission active period. The method may further include monitoring paging according to the received information related to the one or more paging early indications.

In accordance with some example embodiments, a computer program product may perform a method. The method may include obtaining information related to one or more paging early indications. The method may further include monitoring, independent of a discontinuous operation state, at least one of the one or more paging early indications. The at least one monitored paging early indication may indicate at least one of at least one cell discontinuous transmission state, at least one cell discontinuous reception state, a start of at least one cell discontinuous transmission state, a start of at least one cell discontinuous reception state, at least one paging occasion to monitor that corresponds to the at least one monitored paging early indication and independent of at least one cell discontinuous transmission state or at least one cell discontinuous reception state, or at least one paging occasion to monitor that corresponds to the at least one monitored paging early indication where the paging occasion is shifted to a next cell discontinuous transmission active period. The method may further include monitoring paging according to the received information related to the one or more paging early indications.

In accordance with certain example embodiments, an apparatus may include at least one processor and at least one memory storing instructions that, when executed by the at least one processor, cause the apparatus at least to obtain information related to one or more paging early indications. The at least one memory and instructions, when executed by the at least one processor, may further cause the apparatus at least to monitor, independent of a discontinuous operation state, at least one of the one or more paging early indications. The at least one monitored paging early indication may indicate at least one of at least one cell discontinuous transmission state, at least one cell discontinuous reception state, a start of at least one cell discontinuous transmission state, a start of at least one cell discontinuous reception state, at least one paging occasion to monitor that corresponds to the at least one monitored paging early indication and independent of at least one cell discontinuous transmission state or at least one cell discontinuous reception state, or at least one paging occasion to monitor that corresponds to the at least one monitored paging early indication where the paging occasion is shifted to a next cell discontinuous transmission active period. The at least one memory and instructions, when executed by the at least one processor, may further cause the apparatus at least to monitor paging according to the received information related to the one or more paging early indications.

In accordance with various example embodiments, an apparatus may include obtaining circuitry configured to perform obtaining information related to one or more paging early indications. The apparatus may further include monitoring circuitry configured to perform monitoring, independent of a discontinuous operation state, at least one of the one or more paging early indications. The at least one monitored paging early indication may indicate at least one of at least one cell discontinuous transmission state, at least one cell discontinuous reception state, a start of at least one cell discontinuous transmission state, a start of at least one cell discontinuous reception state, at least one paging occasion to monitor that corresponds to the at least one monitored paging early indication and independent of at least one cell discontinuous transmission state or at least one cell discontinuous reception state, or at least one paging occasion to monitor that corresponds to the at least one monitored paging early indication where the paging occasion is shifted to a next cell discontinuous transmission active period. The apparatus may further include monitoring circuitry configured to perform monitoring paging according to the received information related to the one or more paging early indications.

### BRIEF DESCRIPTION OF THE DRAWINGS

For a proper understanding of example embodiments, reference should be made to the accompanying drawings, wherein:

FIG. 1 illustrates a clustered paging scheme;

FIG. 2 illustrates an example of paging early indication (PEI)/paging occasion (PO) configurations dependent upon cell DTX patterns, time in cell DTX, and/or time remaining in cell DTX;

FIG. 3 illustrates an example of POs that are more persistent are configured to be more consecutive to better enable contiguous network sleep;

FIG. 4 illustrates an example of a flow diagram of a method according to various example embodiments;

FIG. 5 illustrates an example of PEI for cell DTX state indication;

FIG. 6 illustrates an example of a flow diagram of a method according to certain example embodiments;

FIG. 7 illustrates an example of another flow diagram of a method according to some example embodiments;

FIG. 8 illustrates an example of another flow diagram of a method according to various example embodiments;

FIG. 9 illustrates an example of various network devices according to some example embodiments; and

FIG. 10 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for paging with cell DTX is not intended to limit the scope of certain example embodiments, but is instead representative of selected example embodiments.

3GPP Release (Rel)-18 includes specified features for network energy saving, including specifying enhancements on cell DTX/discontinuous reception (DRX) mechanisms including alignment of cell DTX/DRX and UE DRX in RRC_CONNECTED mode, and inter-node information exchange on cell DTX/DRX. The cell DTX/DRX mechanism causes the cell to not transmit nor receive for a period of time. 3GPP may reuse the UE DRX definitions of periodicity, slot offsets, and on durations to define the active time and non-active for the cell DTX/DRX.

Group common layer 1 (L1) signaling using physical downlink control channel (PDCCH) for cell DTX/DRX activation and deactivation may be based on new downlink control information (DCI) format 2_X, DCI size budget may not be increased, and the number of required blind decoding (e.g., limit on the number of different DCI sizes the UE can attempt to find in a single PDCCH reception) may not be increased.

In 3GPP Rel-15 NR, time-domain positions of transmitted SSBs within a half frame are semi-statically configured. Further, UE assumes a single periodicity for the transmitted SSBs. The transmission of common signal and channels or reception of random-access signals may limit the gNB ability to use sleep modes to save energy. Currently, system information (SI) update mechanism can adapt the parameters in the cell, such as those associated with downlink common and broadcast signals, such as synchronization signal block (SSB)/SI/paging/cell common PDCCH, and/or the periodicity/availability of uplink random access resources.

Technique A-1 adapts the transmission pattern (when applicable) of downlink common and broadcast signals, such as SSB/SI/paging/cell common PDCCH, and/or the transmission pattern/availability of uplink random access opportunities. Adaptation of the transmission pattern includes changes to periodicity, time resource locations, and omitting of specific signals/channels. The transmission pattern can be adapted semi-statically or dynamically.

Some techniques propose prolonging the paging (i.e., frame) periodicity and confining the paging transmission inside a window: paging frame (PF), as shown in the table below:

| | |
|---|---|
| Prolonging the periodicity of | 1) SSB burst periodicity is 20 ms, and |
| SSB/SIB1/paging: | SIB1 repetition periodicity is 20 ms. |
| 1) SSB burst periodicity is 160 ms, and | 2) PF periodicity at gNB side is 20 ms |
| SIB1 repetition periodicity is 160 ms. | (T = 1280 ms, N = 64). |
| 2) PF periodicity at gNB side is 160 ms | 3) gNB can enter light sleep for Cat 1, |
| (T = 1280 ms, N = 8). | but can only enter micro sleep for Cat |
| 3) gNB can enter light sleep for Cat 1, | 2. |
| but can only enter micro sleep for Cat | |
| 2. | |
| Transmission window of | 1) The transmission window periodicity |
| SSB/SIB1/paging: | is 1280 ms, and the transmission |
| 1) SSB burst periodicity is 20 ms, and | window duration is 160 ms. |
| SIB1 repetition periodicity is 20 ms. | 2) SSB burst periodicity is 20 ms within |
| 2) PF periodicity at gNB side is 20 ms | the transmission window, and SIB1 |
| (T = 1280 ms, N = 64). | repetition periodicity is 20 ms within the |
| 3) gNB can enter light sleep for Cat 1, | transmission window. |
| but can only enter micro sleep for Cat | 3) PF periodicity at gNB side is 160 ms |
| 2. | (T = 1280 ms, N = 8) within the |
| | transmission window. |
| | 4) gNB can enter light sleep for Cat 1, |
| | and can enter both light sleep and micro |
| | sleep for Cat 2 (at the tail of the |
| | transmission window). |

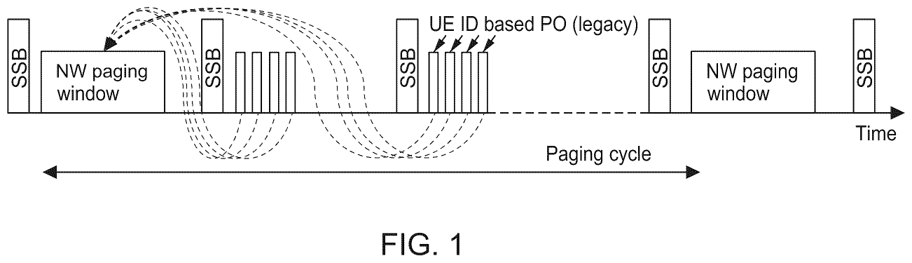

However, this does not describe how the network can switch between cell DTX active and non-active state and the corresponding UE behavior. FIG. 1 depicts an example of how the network can inform the UE that the paging is confined to a window (i.e., UEs have to remap their PO into the window).

Some techniques also defines RAN nodes that can inform the access and mobility management function (AMF) that the RAN node is sleeping. The AMF may then decide to postpone the paging or ask the RAN node to wake up in order to page. Paging priority may be signaled from the AMF to the RAN node according to the following parameter for a message sent by the AMF to an NG-RAN, and used to page a UE in one or several tracking areas:

| IE/Group | | | IE type and | Semantics | | Assigned |
|---|---|---|---|---|---|---|
| Name | Presence | Range | reference | description | Criticality | Criticality |
| Message | M | | 9.3.1.1 | | YES | ignore |
| Type | | | | | | |
| UE Paging | M | | 9.3.3.18 | | YES | ignore |
| Identity | | | | | | |
| Paging | O | | 9.3.1.90 | | YES | ignore |
| DRX | | | | | | |
| TAI List | | 1 | | | YES | ignore |
| for Paging | | | | | | |
| >TAI List | | 1..<maxnoofTAIforPaging> | | | — | |
| for Paging | | | | | | |
| Item | | | | | | |
| >>TAI | M | | 9.3.3.11 | | — | |
| Paging | O | | 9.3.1.78 | | YES | ignore |
| Priority | | | | | | |
| UE Radio | O | | 9.3.1.68 | | YES | ignore |
| Capability | | | | | | |
| for Paging | | | | | | |
| Paging | O | | 9.3.3.22 | | YES | ignore |
| Origin | | | | | | |
| Assistance | O | | 9.3.1.69 | | YES | ignore |
| Data for | | | | | | |
| Paging | | | | | | |
| NB-IoT | O | | 9.3.1.138 | | YES | ignore |
| Paging | | | | | | |
| eDRX | | | | | | |
| Information | | | | | | |
| NB-IoT | O | | 9.3.1.139 | If this IE is | YES | ignore |
| Paging | | | | present, the | | |
| DRX | | | | Paging | | |
| | | | | DRX IE is | | |
| | | | | ignored. | | |
| Enhanced | O | | 9.3.1.140 | | YES | ignore |
| Coverage | | | | | | |
| Restriction | | | | | | |
| WUS | O | | 9.3.1.143 | | YES | ignore |
| Assistance | | | | | | |
| Information | | | | | | |
| E-UTRA | O | | 9.3.1.154 | | YES | ignore |
| Paging | | | | | | |
| eDRX | | | | | | |
| Information | | | | | | |
| CE-mode-B | O | | 9.3.1.155 | | YES | ignore |
| Restricted | | | | | | |
| NR Paging | O | | 9.3.1.227 | | YES | ignore |
| eDRX | | | | | | |
| Information | | | | | | |
| Paging | O | | ENUMERATED | | YES | ignore |
| Cause | | | (voice, . . . ) | | | |
| PEIPS | O | | 9.3.1.232 | | YES | ignore |
| Assistance | | | | | | |
| Information | | | | | | |

An information element (IE) may also indicate the paging priority for paging a UE may be performed by an IE, such as follows:

| | | | | |
|---|---|---|---|---|
| IE/Group Name | Presence | Range | IE type and reference | Semantics description |

| | | | |
|---|---|---|---|
| Paging Priority | M | ENUMERATED | Lower value codepoint |
| | | (PrioLevel1, PrioLevel2, | indicates higher |
| | | PrioLevel3, PrioLevel4, | priority. |
| | | PrioLevel5, PrioLevel6, | |
| | | PrioLevel7, PrioLevel8, | |
| | | . . . ) | |

Thus, the UE may monitor the PEI and PO according to the UE ID, wherein the PEI and/or PO may collide with the cell DTX non-active period, potentially causing the UE to waste energy by monitoring for PEI/PO which may not be transmitted. Furthermore, during cell DTX state, since the paging capacity of a cell can be impacted (e.g., fewer paging records and/or POs), this may trigger loss of high priority pagings, leading to increased call setup times and/or unnecessary paging traffic driven by AMF requesting additional paging attempts in larger areas (i.e., paging escalation due to unsuccessful initial paging)

Certain example embodiments described herein may have various benefits and/or advantages to overcome the disadvantages described above. For example, certain example embodiments may improve UE paging monitoring when the cell applies DTX (e.g., statically or dynamically). For example, some example embodiments may relate to UE behavior for PEI and PO monitoring conditioned on the cell DTX state, which may be known or unknown to the UE, and whether PEI & PO are impacted by the cell DTX state or not. Furthermore, some example embodiments may avoid a UE wasting energy while monitoring for paging when the cell the UE is camping on is in Cell DTX state; priority pagings may not be lost, and the AMF may not trigger re-paging attempts at larger areas when a paging was not transmitted due to cell DTX state. In addition, various example embodiments may avoid wasting energy by allowing lower-priority pagings to be transmitted together with higher priority pagings when suitable. Thus, certain example embodiments discussed below are directed to improvements in computer-related technology.

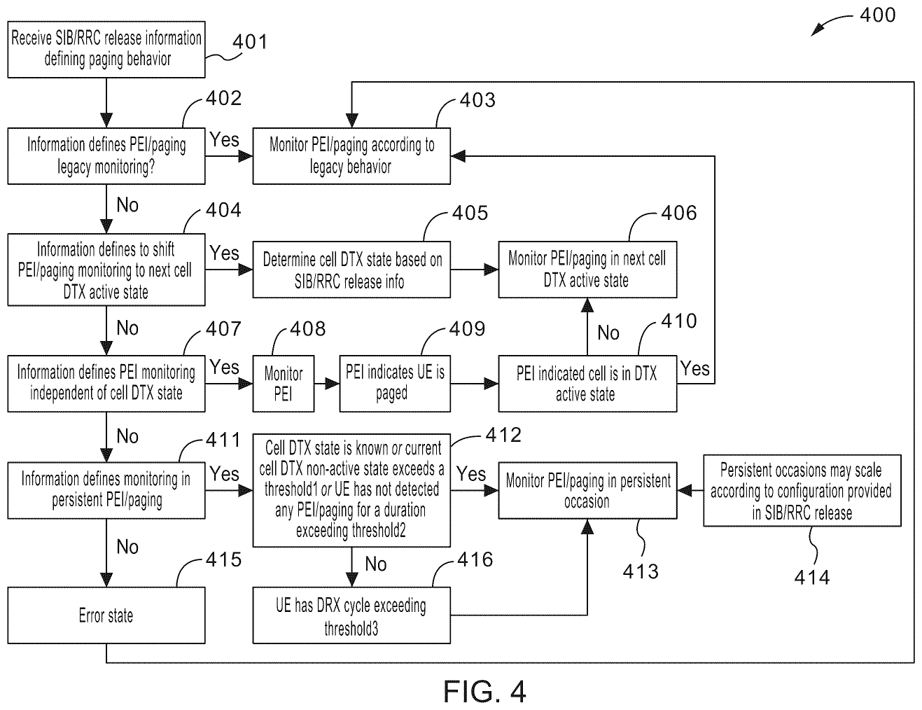

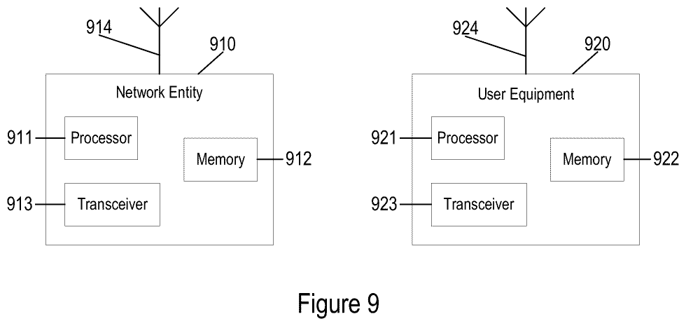

FIG. 4 illustrates an example of a flow diagram of a method 400 that may be performed by a UE, such as UE 920 illustrated in FIG. 9, according to various example embodiments.

At step 401, the method may include receiving system information block (SIB)/radio resource control (RRC) release information, or any other UE-specific RRC signaling, defining paging behavior.

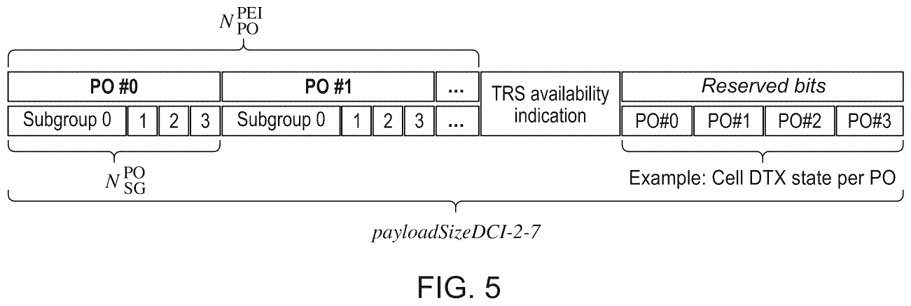

At step 402, the method may further include determining whether the SIB/RRC information defines PEI/paging legacy monitoring. The PEI may be configured for cell DTX state indication, as illustrated in FIG. 5.

In some example embodiments, the PEI may be enhanced to include indications regarding the cell DTX state, cell DRX state, active cell DTX/DRX patterns, and/or the offset/start time of the next cell DTX active period. The current PEI, based on DCI format 2_7, may be configured by N_{PO}^{PEI} (1, 2, 4) defining the number of POs associated to the PEI, and the N_{SG}^{PO} defining the number of subgroups per PO. Furthermore, the DCI format 2_7 may indicate the tracking reference signal availability to the RRC Idle UEs and has a number of reserved bits. The reserved bits can be used to indicate one or more of the above cell DTX/DRX parameters, either per PO or for the entire PEI.

If the SIB/RRC release information defines PEI/paging legacy monitoring at step 402, the method may further include, at step 403, the method may further include monitoring for PEI (if configured) and/or paging. For example, the UE may not need to be aware of the cell DTX state since PEI monitoring occasion (PEI-O), and PO may not be dropped during cell DTX non-active periods. Alternatively, an absence of any indication in SIB may indicate that the UE should monitor according to legacy procedures.

However, if the SIB/RRC release information does not define PEI/paging legacy monitoring at step 402, the method may further include, at step 404, determining whether the SIB/RRC release information indicates that the UE should shift any paging monitoring (which may overlap with cell DTX) to the next cell DTX active period, which may follow the PO determined according to legacy behavior.

In certain example embodiments, the UE may apply rules to cluster & distribute the POs within the cell DTX active time, where the UE knows the cell DTX state. In some example embodiments, the UE may be aware of the cell DTX state based on the SIB providing a static cell DTX configuration. In various example embodiments, the rules for remapping the POs may only be applied for UEs registered for priority services. In certain example embodiments, the POs during cell DTX active time may be mapped to SSB slots employing time/frequency multiplexing. In some example embodiments, the cell in DTX active state may inform the AMF that the transmission of certain paging records will be delayed.

If the SIB/RRC release information defines to shift PEI/paging monitoring to next cell DTX active state at step 404, the method may further include, at step 405, determining cell DTX state based on SIB/RRC release information.

At step 406, the method may further include monitoring PEI/paging in next cell DTX active state.

If the information does not define to shift PEI/paging monitoring to next cell DTX active state at step 404, at step 407, the method may further determining whether the SIB/RRC release information indicates that the UE should perform PEI monitoring independent of the DTX state.

If the SIB/RRC release information defines PEI monitoring independent of the DTX state at step 407, the method may further include, at step 408, monitoring the PEI independent of the cell DTX state.

At step 409, the method may further include the PEI indicating that the PO of the UE or subgroup is paged. The PEI may be able to indicate a subgroup of UEs that they shall monitor the corresponding PO, instead of informing all UEs to monitor the corresponding PO.

At step 410, the method may further including determining whether the PEI indicated cell is in DTX active state. If the PEI indicated cell is not in an DTX active state at step 410, the method may proceed to step 406. However, if the PEI indicated cell is in an DTX active state at step 410, the method may proceed to step 403.

In certain example embodiments, PEI may address up to 4 POs (or more). Thus, PEI signaling may be more efficient than transmitting the up to 4 POs to indicate the DTX/DRX state. Indicating the DRX state in the PEI may enable the UE to determine whether it can initiate RACH for mobile-originated data.

In some example embodiments, the PEI triggers the UE to monitor the corresponding PO, independent of the cell DTX state. This may only apply to high priority paging.

In various example embodiments, if the PEI indicates the cell is in the cell DTX non-active state, and that the subgroup of UEs is paged, the SIB or PEI may define whether the UE should monitor the PO or shift the monitoring to the next cell DTX active time, as in step 403.

If the UE is not aware of the cell DTX pattern (e.g., if it is not provided in SIB), the PEI may indicate the SFN for the start of the cell DTX active period or an offset between the PEI and the next cell DTX active period.

If the information does not define PEI monitoring independent of cell DTX state at step 407, at step 411, the method may further include determining whether the information defines monitoring in persistent PEI/paging.

In certain example embodiments, the SIB may indicate a set of persistent PEI/POs (PPO), where a persistent PEI/PO may be guaranteed to be transmitted independent of the cell DTX state.

In some example embodiments, the PPO may be given as a time window in which all PEI/PO are not dropped.

In various example embodiments, the persistent PO may be defined for UEs with high priority services only (based on 5QI bearers). UEs with low paging priority may skip paging monitoring during the cell DTX non-active periods. For example, the UEs with low paging priority may also monitor the persistent PO if it (the cell) is lowly loaded.

Example embodiments defining the UEs with low paging priority may also monitor the persistent PO if the cell is lowly loaded. If a page message is being transmitted during a persistent PO, then the incremental cost of transmitting additional paging records may be relatively minor. Various example embodiments may utilize a standardized approach which may enable filling up each PPO paging message, without providing too many records, and while also making sure that all of the high priority paging records are included during those PPOs, while also avoiding an excessive number of lower priority UEs monitoring that PO. This may opportunistically provide lower paging latency to lower priority UEs, where delivering the paging records to those low priority UEs is particularly energy efficient (e.g., during paging records going over PPOs where the paging message would otherwise be under-utilized/underfilled).

A low priority UE may determine to monitor the PPO by determining that the loading in that PPO is likely low (but not zero) based on the number of paging records in one or more paging messages and/or the PEI value(s). The UE may utilize a PEI to identify a specific subset of the lower priority UEs which should also monitor that particular PPO. In this way, the network can control on some time scale what fraction of the low priority UEs will monitor the PPO.

In addition, the network may signal a priority threshold to define whether a certain UE monitors the persistent PO or if the configuration on whether or not to monitor it is done on a per UE basis.

In certain example embodiments, the (maximum) number of paging records in the paging message of the persistent PO may be configured to be less than the ordinary paging message, which may provide reliable decoding. The persistent PO may be addressed using a different P-RNTI. If some UEs are not paged using the persistent PO, the RAN node may notify the AMF to avoid/control the paging escalation (e.g., re-paging in other cells).

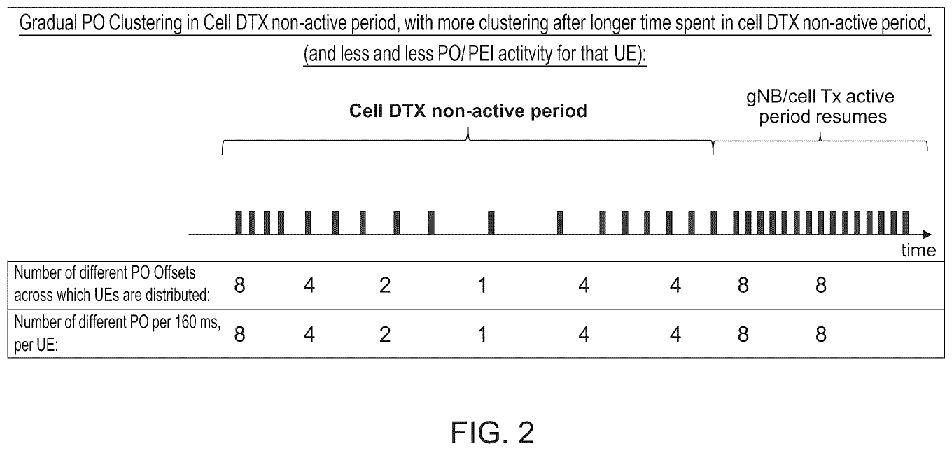

In various example embodiments, as shown in FIG. 2, if the UE has received an explicit indication of the cell DTX state (e.g., via SIB or PEI) or the current cell DTX non-active period has exceeded a (e.g., network-configured) threshold or the UE has not detected any PEI/PO for a (e.g., network-configured) time interval, the UE may fall back to the persistent PEI/PO. For example, the shift to monitor the persistent PO may be triggered only during the cell DTX non-active periods. The network may need to identify when the UE performs fallback to the persistent PEI/PO. The network implementation may be based on detecting that the UE is not reacting to a paging message (i.e., no subsequent RACH), and the network would need to handle the error case where the network thinks the UE received the PEI/PO paging attempt, although the UE did not actually receive that paging attempt.

In certain example embodiments, the switch to the persistent PEI/POs may be based on an indication in the PEI or PO itself. Furthermore, there may be different persistent PEI/PO configurations for different cell DTX patterns. As shown in FIG. 2, if the current cell DTX non-active duration has exceeded a threshold, the number of PO per time interval may be further reduced. If the time interval until the next cell DTX active duration is less than another threshold, the number of PO per time interval may be increased.

In some example embodiments, an extra persistent PEI/PO (PPO or EPPO) may be defined to only be applicable to UEs with high(er) priority paging options and/or with long DRX (paging) cycles. For example, if the UE has eDRX cycle of more than x minutes/hours, then the UE's PEI/PO is (extra) persistent.

Alternatively, UEs with long DRX cycles (and/or high priority paging options) have their PO mapped to pre-defined (in SIB) (Extra Persistent) POs (EPPO). For example, the UEs may monitor the first EPPO which follows their own UE ID based PO.

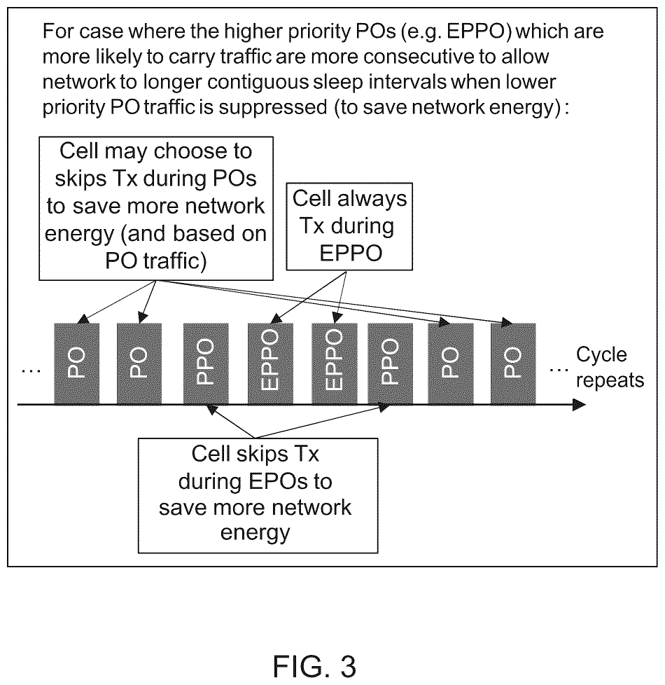

As shown in FIG. 3, these EPPOs may be defined such that they are consecutive (e.g., so the order may be repeating, such as PO, . . . , PO, PPO, . . . , PPO, EPPO, EPPO, . . . , EPPO, PPO, . . . , PPO, and then repeating . . . ) to enable the cell to enter deeper/longer contiguous sleep during, for example, the (Normal PO, Normal PO, . . . Normal PO) portion of the cycle in the event that the network chooses to save more network energy and not deliver any signaling during the lower priority POs (and PPOs).

In various example embodiments, the persistent PO may be defined to be co-located in time and/or frequency domains with the SSB (e.g., every Xₜₕ SSB). This may minimize the network active time and save energy. For example, the persistent PO can be shifted to right before/after the Xₜₕ SSB (referenced to the SFN) or be shifted to occur at the nearest SSB before/after the PO.

If the information defines monitoring in persistent PEI/paging at step 411, the method may further include, at step 412, determining whether cell DTX state is known or current cell DTX non-active state exceeds a first threshold T₁ or that the UE has not detected any PEI/paging for a duration exceeding a second threshold T₂.

If the cell DTX state is known or current cell DTX non-active state exceeds a first threshold T₁ or that the UE has not detected any PEI/paging for a duration exceeding a second threshold T₂, at step 412, the method may further include, at step 413, monitoring PEI/paging in persistent occasion.

If the cell DTX state is not known, current cell DTX non-active state does not exceed a first threshold T₁, and that the UE has not detected any PEI/paging for a duration exceeding a second threshold T₂ at step 412, the method may further include, at step 416, the UE having a DRX cycle exceeding a third threshold T₃, and then proceeding to step 413.

If the information does not define monitoring in persistent PEI/paging at step 411, the method may further include, at step 415, entering an error state, and proceeding to step 403.

At step 414, the method may further include that persistent occasions may scale according to a configuration provided in SIB/RRC release, and proceeding to step 413.

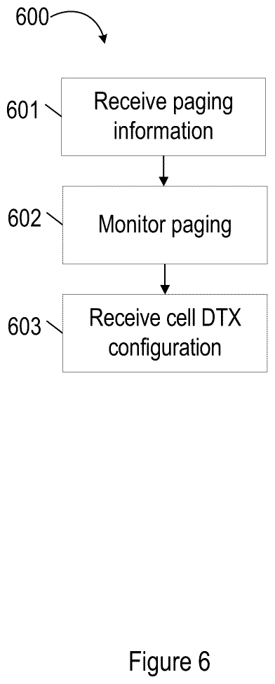

FIG. 6 illustrates an example of a flow diagram of a method 600 that may be performed by a UE, such as UE 920 illustrated in FIG. 9, according to various example embodiments.

At step 601, the method may include receiving, by the user equipment, paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging.

At step 602, the method may further include monitoring, by the user equipment, paging according to the received paging information.

In certain example embodiments, the paging monitoring may include monitoring at least one of PEI, low-power wake-up signal, paging downlink control information of the paging occasion, a short message of the paging downlink control information of the paging occasion, or a paging message related to the paging occasion.

In some example embodiments, the paging monitoring may be configured in at least one of system information, preconfigured information, dedicated signaling, PEI, low-power wake-up signal, a short message of paging downlink control information of the paging occasion, or a paging message related to the paging occasion.

In various example embodiments, the paging information defining to shift paging monitoring to a next cell discontinuous transmission active state may include at least one of at least one indication of the paging occasion in the cell discontinuous transmission active time, remapping the paging occasion only applied for user equipment registered for priority services, and mapping the paging occasion during cell discontinuous transmission active time to synchronization signal block slots employing time/frequency multiplexing.

In certain example embodiments, the paging information defining paging monitoring independent of discontinuous transmission may include indicating at least one of monitoring of PEI, monitoring of low-power wake-up signal, the short message of the paging downlink control information of the paging occasion, or the paging message related to the paging occasion. In further example embodiments, the PEI or the low-power wake-up signal may indicate at least one of the cell discontinuous transmission state or discontinuous reception state or the start of the next cell discontinuous transmission state or discontinuous reception active period.

In some example embodiments, the paging information defining monitoring in persistent paging may include at least one of a set of at least one of persistent PEI, paging occasion, or low-power wake-up signal, or a configuration for the user equipment to monitor for persistent paging occasion. A persistent PEI/paging occasion/low-power wake-up signal is transmitted independent of the cell discontinuous transmission state.

In various example embodiments, the persistent paging occasion further includes at least one of a persistent paging occasion comprising a time window during which PEI/paging occasions are not dropped, a persistent paging occasion scrambled with a radio network temporary identifier different from paging occasions which are not transmitted during a cell discontinuous transmission non-active state, a persistent paging occasion defined for the user equipment with at least one discontinuous reception cycle exceeding a threshold, a persistent paging occasion mapped to at least one synchronization signal block slot, a persistent paging occasion is defined for user equipment with high priority services only, or a persistent paging occasion below a threshold (e.g., low load) monitored by the user equipment with low paging priority. For example, the threshold may include a number of UE that are paged with the persistent PO (i.e., load per PO), or a number of persistent PO containing PO for any UE (i.e., load per paging cycle).

At step 603, the method may further include receiving, by the user equipment, at least one cell discontinuous transmission configuration.

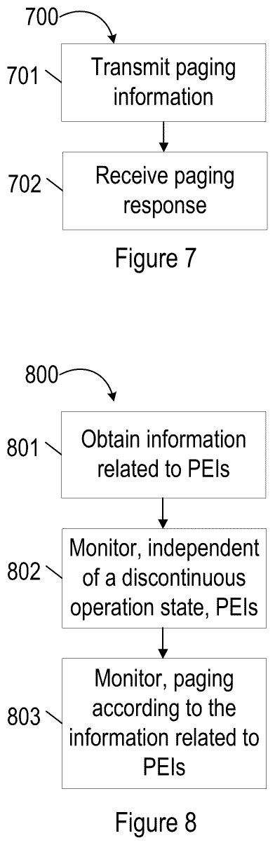

FIG. 7 illustrates an example of a flow diagram of a method 700 that may be performed by a NE, such as NE 910 illustrated in FIG. 9, according to various example embodiments.

At step 701, the method may include transmitting, by a network entity, paging information related to at least one discontinuous transmission state or discontinuous reception state. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging.

At step 702, the method may further include receiving, by the network entity, a paging response according to the transmitted paging information.

FIG. 8 illustrates an example of a flow diagram of a method 800 that may be performed by a UE, such as UE 920 illustrated in FIG. 9, according to various example embodiments.

At step 801, the method may include obtaining, by a user equipment, information related to one or more paging early indications.

At step 802, the method may further include monitoring, by the user equipment, independent of a discontinuous operation state, at least one of the one or more paging early indications.

In certain example embodiments, the at least one monitored paging early indication may indicate at least one of at least one cell discontinuous transmission state, at least one cell discontinuous reception state, a start of at least one cell discontinuous transmission state, a start of at least one cell discontinuous reception state, at least one paging occasion to monitor that corresponds to the at least one monitored paging early indication and independent of at least one cell discontinuous transmission state or at least one cell discontinuous reception state, or at least one paging occasion to monitor that corresponds to the at least one monitored paging early indication where the paging occasion is shifted to a next cell discontinuous transmission active period.

In some example embodiments, the monitoring at least one of the one or more paging early indications comprises monitoring one or more of paging downlink control information of the at least one paging occasion, at least one short message of the paging downlink control information, or at least one paging message related to the at least one monitored paging occasion.

In various example embodiments, the monitoring at least one of the one or more paging early indications is configured according to at least one of system information, preconfigured information, dedicated signaling, at least one of the one or more paging early indications, at least one short message of paging downlink control information of the at least one paging occasion, or at least one paging message related to the at least one monitored paging occasion.

At step 803, the method may further include monitoring, by the user equipment, paging according to the received information related to the one or more paging early indications.

In certain example embodiments, the method may further include receiving, by the user equipment, at least one cell discontinuous transmission configuration.

In some example embodiments, the shifting the paging occasion may be performed according to at least one of at least one indication of the paging occasion in at least one cell discontinuous transmission active time, remapping the at least one paging occasion only applied for the user equipment registered for at least one priority service, or mapping the at least one paging occasion during cell discontinuous transmission active time to synchronization signal block slots employing at least one of time multiplexing or frequency multiplexing.

In various example embodiments, the information related to one or more paging early indications may define monitoring in persistent paging and may further include at least one of a set of at least one of persistent paging early indication or paging occasion, or a configuration for the user equipment to monitor for persistent paging early indication or paging occasion. At least one of a persistent paging early indication or paging occasion is transmitted, independent of the cell discontinuous transmission state.

In certain example embodiments, the persistent paging further may include at least one of a persistent paging occasion comprising a time window during which at least one of a paging early indication or paging occasion are not dropped, a persistent paging early indication or paging occasion scrambled with a radio network temporary identifier different from paging early indication or paging occasions which are not transmitted during a cell discontinuous transmission non-active state, a persistent paging early indication or paging occasion defined for the user equipment with at least one discontinuous reception cycle exceeding a threshold, a persistent paging early indication or paging occasion mapped to at least one synchronization signal block slot, a persistent paging early indication or paging occasion is defined for user equipment with high priority services only, or a persistent paging occasion below a threshold monitored by the user equipment with low paging priority.

FIG. 9 illustrates an example of a system according to certain example embodiments. In one example embodiment, a system may include multiple devices, such as, for example, NE 910 and/or UE 920.

NE 910 may be one or more of a base station (e.g., 3G UMTS NodeB, 4G LTE Evolved NodeB, or 5G NR Next Generation NodeB), a serving gateway, a server, and/or any other access node or combination thereof.

NE 910 may further include at least one gNB-centralized unit (CU), which may be associated with at least one gNB-distributed unit (DU). The at least one gNB-CU and the at least one gNB-DU may be in communication via at least one F1 interface, at least one Xₙ-C interface, and/or at least one NG interface via a 5^{th} generation core (5GC).

UE 920 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 910 and/or UE 920 may be one or more of a citizens broadband radio service device (CBSD).

NE 910 and/or UE 920 may include at least one processor, respectively indicated as 911 and 921. Processors 911 and 921 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 912 and 922. The memory may be fixed or removable. The memory may include computer program instructions or computer code contained therein. Memories 912 and 922 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 911 and 921, memories 912 and 922, and any subset thereof, may be configured to provide means corresponding to the various blocks of FIGS. 4-7. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 9, transceivers 913 and 923 may be provided, and one or more devices may also include at least one antenna, respectively illustrated as 914 and 924. The device may have many antennas, such as an array of antennas configured for multiple input multiple output (MIMO) communications, or multiple antennas for multiple RATs. Other configurations of these devices, for example, may be provided. Transceivers 913 and 923 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 4-7). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 4-7. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

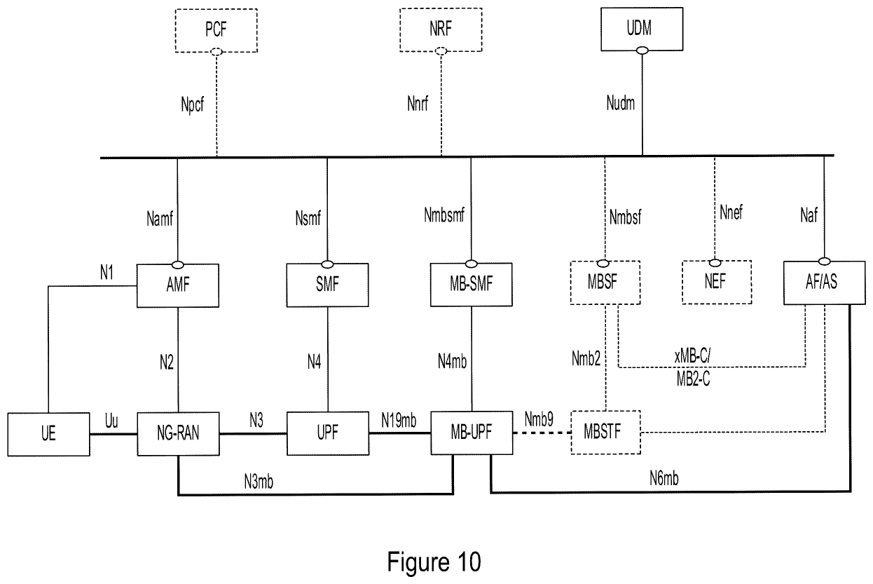

FIG. 10 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 10 may be similar to NE 910 and UE 920, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 911 and 921, and memories 912 and 922, may be included in or may form a part of processing circuitry or control circuitry. In addition, in some example embodiments, transceivers 913 and 923 may be included in or may form a part of transceiving circuitry.

In some example embodiments, an apparatus (e.g., NE 910 and/or UE 920) may include means for performing a method, a process, or any of the variants discussed herein. Examples of the means may include one or more processors, memory, controllers, transmitters, receivers, and/or computer program code for causing the performance of the operations.

In various example embodiments, apparatus 920 may be controlled by memory 922 and processor 921 to receive paging information related to at least one discontinuous transmission state or discontinuous reception state, and monitor paging according to the received paging information. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging.

Certain example embodiments may be directed to an apparatus that includes means for performing any of the methods described herein including, for example, means for receiving paging information related to at least one discontinuous transmission state or discontinuous reception state, and means for monitoring paging according to the received paging information. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging.

In various example embodiments, apparatus 910 may be controlled by memory 912 and processor 911 to transmit paging information related to at least one discontinuous transmission state or discontinuous reception state, and receive a paging response according to the transmitted paging information. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging.

Certain example embodiments may be directed to an apparatus that includes means for performing any of the methods described herein including, for example, means for transmitting paging information related to at least one discontinuous transmission state or discontinuous reception state, and means for receiving a paging response according to the transmitted paging information. The paging information indicates a user equipment paging monitoring, the paging monitoring comprising at least one of a paging legacy monitoring, a paging monitoring shift to a next cell discontinuous transmission active state, a paging monitoring independent of discontinuous transmission, or a monitoring in persistent paging.

In various example embodiments, apparatus 920 may be controlled by memory 922 and processor 921 to obtain information related to one or more paging early indications, monitoring, independent of a discontinuous operation state, at least one of the one or more paging early indications, and monitor paging according to the received information related to the one or more paging early indications. The at least one monitored paging early indication indicates at least one of at least one cell discontinuous transmission state, at least one cell discontinuous reception state, a start of at least one cell discontinuous transmission state, a start of at least one cell discontinuous reception state, at least one paging occasion to monitor that corresponds to the at least one monitored paging early indication and independent of at least one cell discontinuous transmission state or at least one cell discontinuous reception state, or at least one paging occasion to monitor that corresponds to the at least one monitored paging early indication where the paging occasion is shifted to a next cell discontinuous transmission active period.

Certain example embodiments may be directed to an apparatus that includes means for performing any of the methods described herein including, for example, means for obtaining, by a user equipment, information related to one or more paging early indications, means for monitoring, independent of a discontinuous operation state, at least one of the one or more paging early indications, and means for monitoring paging according to the received information related to the one or more paging early indications. The at least one monitored paging early indication indicates at least one of at least one cell discontinuous transmission state, at least one cell discontinuous reception state, a start of at least one cell discontinuous transmission state, a start of at least one cell discontinuous reception state, at least one paging occasion to monitor that corresponds to the at least one monitored paging early indication and independent of at least one cell discontinuous transmission state or at least one cell discontinuous reception state, or at least one paging occasion to monitor that corresponds to the at least one monitored paging early indication where the paging occasion is shifted to a next cell discontinuous transmission active period.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

3GPP 3^{rd} Generation Partnership Project
5G 5^{th} Generation
5GC 5^{th} Generation Core
6G 6^{th} Generation
AF Application Function
AMF Access and Mobility Management Function
ASIC Application Specific Integrated Circuit
CBSD Citizens Broadband Radio Service Device
CPU Central Processing Unit
CU Centralized Unit
DCI Downlink Control Information
DRX Discontinuous Reception
DTX Discontinuous Transmission
DU Distributed Unit
eMBB Enhanced Mobile Broadband
eNB Evolved Node B
EPPO Extra Persistent Paging Occasion
gNB Next Generation Node B
GPS Global Positioning System
HDD Hard Disk Drive
IE Information Element
IoT Internet of Things
L1 Layer 1
LTE Long-Term Evolution
LTE-A Long-Term Evolution Advanced
MEMS Micro Electrical Mechanical System
MIMO Multiple Input Multiple Output
mMTC Massive Machine Type Communication
NE Network Entity
NES Network Energy Saving
NG Next Generation
NG-eNB Next Generation Evolved Node B
NG-RAN Next Generation Radio Access Network
NR New Radio
PDA Personal Digital Assistance
PDCCH Physical Downlink Control Channel
PEI Paging Early Indication
PEI-O Paging Early Indication Monitoring Occasion
PF Paging Frame
PO Paging Occasion
PPO Persistent Paging Occasion
P-RNTI Paging Radio Network Temporary Identifier
QoS Quality of Service
RACH Random Access Channel
RAM Random Access Memory
RAN Radio Access Network
RAT Radio Access Technology
RF Radio Frequency
ROM Read-Only Memory
RRC Radio Resource Control
SI System Information
SIB System Information Block
SSB Synchronization Signal Block
TAI Tracking Area Identity
UE User Equipment
UMTS Universal Mobile Telecommunications System
UPF User Plane Function
URLLC Ultra-Reliable and Low-Latency Communication
UTRAN Universal Mobile Telecommunications System Terrestrial Radio Access Network

We claim:

1. A method comprising:
obtaining, by a user equipment, information related to one or more paging early indications;
monitoring, by the user equipment, independent of a discontinuous operation state, at least one of the one or more paging early indications, wherein the at least one monitored paging early indication indicates at least one of:
at least one cell discontinuous transmission state;
at least one cell discontinuous reception state;
a start of at least one cell discontinuous transmission state;
a start of at least one cell discontinuous reception state;
at least one paging occasion to monitor that corresponds to the at least one monitored paging early indication and independent of at least one cell discontinuous transmission state or at least one cell discontinuous reception state; or
at least one paging occasion to monitor that corresponds to the at least one monitored paging early indication where the paging occasion is shifted to a next cell discontinuous transmission active period; and
monitoring, by the user equipment, paging according to the received information related to the one or more paging early indications.

2. The method of claim 1, wherein the monitoring at least one of the one or more paging early indications comprises monitoring one or more of:
paging downlink control information of the at least one paging occasion;
at least one short message of the paging downlink control information; or
at least one paging message related to the at least one monitored paging occasion.

3. The method of claim 1, wherein the monitoring at least one of the one or more paging early indications is configured according to at least one of:
system information;
preconfigured information;
dedicated signaling;
at least one of the one or more paging early indications;
at least one short message of paging downlink control information of the at least one paging occasion; or
at least one paging message related to the at least one monitored paging occasion.

4. The method of claim 1, further comprising:
receiving, by the user equipment, at least one cell discontinuous transmission configuration.

5. The method of claim 1, wherein the shifting the paging occasion is performed according to at least one of:
at least one indication of the paging occasion in at least one cell discontinuous transmission active time;
remapping the at least one paging occasion only applied for the user equipment registered for at least one priority service; or
mapping the at least one paging occasion during cell discontinuous transmission active time to synchronization signal block slots employing at least one of time multiplexing or frequency multiplexing.

6. The method of claim 1, wherein the information related to one or more paging early indications define monitoring in persistent paging and further comprises at least one of:
a set of at least one of persistent paging early indication or paging occasion, wherein at least one of a persistent paging early indication or paging occasion is transmitted independent of the cell discontinuous transmission state; or
a configuration for the user equipment to monitor for persistent paging early indication or paging occasion.

7. The method of claim 6, wherein the persistent paging further comprises at least one of:
a persistent paging occasion comprising a time window during which at least one of a paging early indication or paging occasion are not dropped;
a persistent paging early indication or paging occasion scrambled with a radio network temporary identifier different from paging early indication or paging occasions which are not transmitted during a cell discontinuous transmission non-active state;
a persistent paging early indication or paging occasion defined for the user equipment with at least one discontinuous reception cycle exceeding a threshold;
a persistent paging early indication or paging occasion mapped to at least one synchronization signal block slot;
a persistent paging early indication or paging occasion is defined for user equipment with high priority services only; or
a persistent paging occasion below a threshold monitored by the user equipment with low paging priority.

8. A user equipment comprising:
at least one processor; and
at least one memory storing instructions that, when executed by the at least one processor, cause the apparatus at least to:
obtain information related to one or more paging early indications;
monitor, independent of a discontinuous operation state, at least one of the one or more paging early indications, wherein the at least one monitored paging early indication indicates at least one of:
at least one cell discontinuous transmission state;
at least one cell discontinuous reception state;
a start of at least one cell discontinuous transmission state;
a start of at least one cell discontinuous reception state;
at least one paging occasion to monitor that corresponds to the at least one monitored paging early indication and independent of at least one cell discontinuous transmission state or at least one cell discontinuous reception state; or
at least one paging occasion to monitor that corresponds to the at least one monitored paging early indication where the paging occasion is shifted to a next cell discontinuous transmission active period; and
monitor paging according to the received information related to the one or more paging early indications.

9. The user equipment of claim 8, wherein the monitoring at least one of the one or more paging early indications comprises monitoring one or more of:
paging downlink control information of the at least one paging occasion;
at least one short message of the paging downlink control information; or
at least one paging message related to the at least one monitored paging occasion.

10. The user equipment of claim 8, wherein the monitoring at least one of the one or more paging early indications is configured according to at least one of:
system information;
preconfigured information;
dedicated signaling;
at least one of the one or more paging early indications;
at least one short message of paging downlink control information of the at least one paging occasion; or
at least one paging message related to the at least one monitored paging occasion.

11. The user equipment of claim 8, wherein the at least one memory and the instructions, when executed by the at least one processor, further cause the user equipment at least to:
receive at least one cell discontinuous transmission configuration.

12. The user equipment of claim 8, wherein the shifting the paging occasion is performed according to at least one of:
at least one indication of the paging occasion in at least one cell discontinuous transmission active time;
remapping the at least one paging occasion only applied for the user equipment registered for at least one priority service; or
mapping the at least one paging occasion during cell discontinuous transmission active time to synchronization signal block slots employing at least one of time multiplexing or frequency multiplexing.

13. The user equipment of claim 8, wherein the information related to one or more paging early indications define monitoring in persistent paging and further comprises at least one of:
a set of at least one of persistent paging early indication or paging occasion, wherein at least one of a persistent paging early indication or paging occasion is transmitted independent of the cell discontinuous transmission state; or
a configuration for the user equipment to monitor for persistent paging early indication or paging occasion.

14. The user equipment of claim 13, wherein the persistent paging further comprises at least one of:
a persistent paging occasion comprising a time window during which at least one of a paging early indication or paging occasion are not dropped;
a persistent paging early indication or paging occasion scrambled with a radio network temporary identifier different from paging early indication or paging occasions which are not transmitted during a cell discontinuous transmission non-active state;
a persistent paging early indication or paging occasion defined for the user equipment with at least one discontinuous reception cycle exceeding a threshold;
a persistent paging early indication or paging occasion mapped to at least one synchronization signal block slot;
a persistent paging early indication or paging occasion is defined for user equipment with high priority services only; or
a persistent paging occasion below a threshold monitored by the user equipment with low paging priority.
